(19) United States
(12) Patent Application Publication
(10) Pub. No.: US 2011/0153184 A1
(43) Pub. Date: Jun. 23, 2011

(54) TRANSPORTATION SYSTEM USING ELECTRIC AUTOMOBILE

(75) Inventor: Nam Pyo Suh, Daejeon (KR)

(73) Assignee: Korea Advanced Institute of Science and Technology, Daejeon (KR)

(21) Appl. No.: 13/061,771

(22) PCT Filed: Sep. 1, 2009
(86) PCT No.: PCT/KR2009/004921

§ 371 Date: Mar. 2, 2011

(30) Foreign Application Priority Data
Sep. 2, 2008 (KR) 10-2008-0086259

(51) Int. Cl. G06F 19/00; B60M 1/30

(52) U.S. Cl. 701/117; 191/22 C; 191/45 R

(57) ABSTRACT

The present invention relates to a transportation system using an electric automobile. The transportation system using the electric automobile comprises the electric automobile and an electricity-supply unit which supplies electricity to the electric automobile. The electric automobile charges a battery included when the electricity is supplied from an external source in motion, using some or all of the electricity and is driven by the electricity of the battery when the electricity supply to the automobile in motion is stopped.

### TECHNICAL FIELD

The present invention relates to a transportation system using an electrical vehicle; and more particularly, to a transportation system using an electrical vehicle, which is capable of charging a battery while traveling using electric power supplied from outside when the vehicle is moving.

### BACKGROUND OF THE INVENTION

In general, a vehicle runs using fossil fuels. In this case, exhaust gas emitted from the vehicle after burning the fuels to drive the engine cause environmental problems, such as air pollution and global warming.

To solve these problems, studies about vehicles using alternative energies have been under way. Vehicles of this type include vehicles using electricity charged in a battery, vehicles using a fuel cell consisting of quantities of hydrogen and oxygen, vehicles using solar energy and the like. Some of the vehicles using the electricity charged in the battery have been put to practical use.

However, the vehicles using the electricity charged in the battery have a problem in that the vehicles have a difficulty in traveling a long distance since the capacity of the battery is not yet sufficiently large. That is, in order for an electrical vehicle to have practicality, the electrical vehicle needs to be able to travel about 400 kilometers once fully charged. However, if this travel distance is achieved by the conventional technique, the battery becomes heavier, thus reducing the efficiency of the electrical vehicle. In addition, even when moving the same travel distance, an electrical vehicle equipped with a more lightweight battery has higher efficiency. Overall, as the capacity of the battery increases, the weight of the battery also increases accordingly. Thus, if it is possible to make the electrical vehicle move a farther distance with a battery having a lower capacity, the efficiency of the electrical vehicle is enhanced.

Further, a vehicle using fossil fuels only needs to stop at a gas station to fuel up, whereas it takes a long time to charge the battery of the electrical vehicle, thereby making it difficult to provide battery charging stations like the gas stations.

### DISCLOSURE

### Technical Problem

In view of the above, the present invention provides a transportation system, which enables an electrical vehicle with a low capacity battery to move a long travel distance without being charged for a long time at a stopped condition.

Further, the present invention provides a transportation system, which guides an electrical vehicle in various ways and eases traffic congestion.

### Technical Solution

In accordance with a first aspect of the present invention, there is provided a transportation system using an electrical vehicle, the system including: a power supply device installed below a surface of a road along the road; and an electrical vehicle including a steering aid device for guiding the movement direction of the electrical vehicle, a battery for providing charged power if required for driving, a power acquisition device for receiving power by electrical connection to the power supply device, and a connector to be mechanically detachably connected to another electrical vehicle to travel, with being connected to the another electrical vehicle moving along the same path, wherein, if the electrical vehicle travels on the road where the power supply device is installed, the battery is charged using at least part of the electric power supplied from the power supply device, and, if the electrical vehicle travels on a road where the power supply device is not installed, the electrical vehicle is driven on the electric power charged in the battery.

In accordance with a second aspect of the present invention, there is provided a method for driving plural electrical vehicles by connecting the electrical vehicles in a transportation system using an electrical vehicle described above, the method including: checking the destinations and predicted movement paths of electrical vehicles moving in the front or back of a first electrical vehicle; as a result of checking the destinations and predicted movement paths of the electrical vehicles, if there is an electrical vehicle identified as moving more than a predetermined distance along the same movement path as the first electrical vehicle, connecting the identified electrical vehicle and the first electrical vehicle by connection members of the electrical vehicles; and determining whether to drive each of the connected electrical vehicles in consideration of the total load of the connected electrical vehicles.

In accordance with a third aspect of the present invention, there is provided a transportation system using an electrical vehicle, the system including: a power supply device installed below the surface of a road along the road; and an electrical vehicle including a battery for providing charged electric power if required for driving, and a power acquisition device for receiving electric power by electrical connection to the power supply device and charging the battery, wherein the power supply device includes at least one power supply line which extends along the road underneath the road surface and is flat on at least a portion of a transverse cross-section, and wherein the power acquisition device includes: a connector which is flat on at least a portion of a transverse cross-section, the flat portion of the power supply line and the flat portion of the connector being electrically connected by contacting each other; and a connection maintenance unit for pressing the connector against the power supply line by elasticity so as to enable the connector and the power supply line to maintain a good electrical connection state.

In accordance with a fourth aspect of the present invention, there is provided a transportation system using an electrical vehicle, the system including: a power supply device installed below the surface of a road along the road; and an electrical vehicle including a battery for providing charged electric power if required for driving, and a power acquisition device for receiving electric power by electrical connection to the power supply device and charging the battery, wherein the power supply device is formed in a substantially L-shape which extends along the road underneath the road surface and has an upper member and a side member, and the power supply device includes: a power supply line for supplying electricity to the bottom surface of the upper member; a duct for compressed air extending along the side member of the power supply line; and a plurality of air exhaust ports, provided on the side member of the power supply line, for communicating the duct for compressed air with a lower space of the upper member of the power supply line, and wherein the power acquisition device of the electrical vehicle includes: a connector for maintaining a contact state in a manner of rolling friction with the bottom surface of the upper member of the power supply line of the power supply device during driving; and a connection maintenance unit for pressing the connector against the bottom surface of the upper member of the power supply line by elasticity to maintain a good electrical connection state.

### Advantageous Effects

According to the transportation system in accordance with an embodiment of the present invention, when the electrical vehicle moves along the electricity supply device, there is no need to be charged for a long time at a stopped condition since the power is provided to chare the battery of the electrical vehicle.

Further, since the electrical vehicle uses electricity as driving energy, it is possible to prevent air pollution caused by exhaust gas differently from vehicle using fossil fuel such as gasoline.

### BRIEF DESCRIPTION OF THE DRAWINGS

FIG. 1 is a view schematically showing a transportation system in accordance with an embodiment of the present invention;

FIG. 2 is a view schematically showing an electricity supply device and a connector of an electrical vehicle in the transportation system in accordance with the embodiment of the present invention;

FIG. 3 is a view schematically showing a connector of an electrical vehicle and an electricity supply device in the transportation system in accordance with another embodiment of the present invention;

FIG. 4 is a flow chart illustrating a method for supplying electric power to the electrical vehicle in the transportation system in accordance with an embodiment of the present invention;

FIG. 5 is a view showing a groove for reducing abrasion and friction between a power line and the connector in accordance with an embodiment of the present invention; and

FIG. 6 is a view schematically showing travel control performed by a central control server in accordance with an embodiment of the present invention.

### BEST MODE FOR THE INVENTION

Design parameters of a transportation system in accordance with an embodiment of the present invention can be determined as follows by the theory of axiomatic design.

The functional requirements (FRs) of the transportation system are as follows:

FR1=Provide electricity to the electrical vehicle when traveling a long distance

FR2=Provide the ability to move in and out of the city

FR3=Minimize traffic congestion

FR4=Guide the vehicle

Further, the constraints (Cs) of the transportation system in accordance with the present invention are as follows:

C1=Minimize the operating costs

C2=Minimize the vehicle weight

C3=Minimize the vehicle cost

C4=Minimize the overall cost to society

C5=No environmental pollution

The design parameters (DPs) satisfying the above-mentioned functional requirements and constraints are as follows:

DP1=Underground power lines

DP2=Electrical battery

DP3=Parallel lanes and the widths of vehicles

DP4=Steering of the front wheel either based on the electro magnetic signal from power lines or mechanically using a groove on the road sr steering of the wheel by the driver following the lines painted on the road, etc.

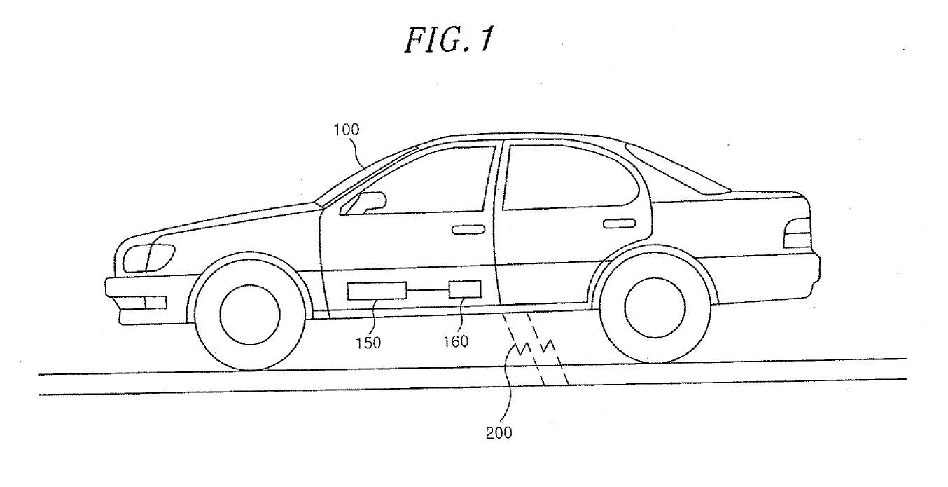

As stated above, the transportation system in accordance with an embodiment of the present invention, which is implemented based on the design parameters determined by the theory of axiomatic design will be described in detail with reference to FIG. 1.

The transportation system in accordance with the embodiment of the present invention includes an electrical vehicle 100 and a power supply device 200 for supplying electric power to the electrical vehicle. The electricity supply device 200 may be installed in a road on which the electrical vehicle 100 travels, for example, on the surface of the road or under the road.

The electrical vehicle 100 includes an electricity charging battery 150 and a charging circuit 160. The electrical vehicle 100 travels using the power supplied from the electricity supply device 200 while moving or stopped, and charges the battery 150 using at least some of the supplied power, and is driven using the power charged in the battery 150 if a power supply from outside is stopped while moving. The supplied electric power is charged in the battery 150 through the charging circuit 160 from the electricity supply device 200.

Preferably, the electrical vehicle in accordance with the present invention is a car that seats two people, considering that most transportation is done with 1 to 2occupants in the car.

The electricity supply device 200 supplies power to the electrical vehicle 100 while the electrical vehicle is moving along a road with the electricity supply device 200 installed therein or while stopped on the road. The electricity supply device 200 may be installed only in the main roads of a city but not on peripheral roads or alleys of the city. Multiple electricity supply devices that are installed parallel to each other may be provided in the road.

When the electricity supply device 200 moves along the road provided with the electricity supply device 200, the electrical vehicle 100 can be supplied with the power from the electricity supply device 200. On the other hand, when the electricity supply device 200 veers off the road, the electrical vehicle 100 cannot be supplied with power from the electricity supply device 200 and thus is driven using the power supplied from the battery 150. That is, when moving a long travel distance over a relatively long period of time, the electrical vehicle 100 is driven dependent on the power supplied from the electricity supply device 200, and, when veering off the road provide with the electricity supply device 200, the electrical vehicle 100 is driven using the power of the battery 150 incorporated in the electrical vehicle 100. Thus, even if the electrical vehicle 100 has the battery 150 having a relatively low capacity incorporated therein, it is possible to travel a long distance over a long period of time in city districts and peripheral areas. Even when the electrical vehicle 100 is parked at the driver's residence or in a parking lot and does not run for a long period of time, the battery 150 can be charged.

The seats of the electrical vehicle 100 can be arranged, e.g., in the length direction of the vehicle 100. Consequently, the width of the vehicle becomes smaller, thus allowing a large number of vehicles to simultaneously move in the same direction or in the opposite direction even on a narrow road.

In addition, the car body of the electrical vehicle 100 can be made of a composite material for lightweight construction. Examples of the composite material may include glass fiber, carbon fiber, and aramid fiber. In this case, the car body is lightweight compared to a car body made of metal. For a car body made of a composite material, it is preferable that the car body is manufactured to have a sandwich structure by filament winding.

The electricity supply device 200 is preferably installed underneath a main road. If the electricity supply device 200 is installed on the surface of a road or above the surface, there is a risk that, e.g., a pedestrian who crosses the road may get an electric shock. If the electricity supply device 200 is installed underground, the risk of a pedestrian getting an electric shock will be reduced. In this case, there is a need for facilities that quickly and easily drain water to prevent water generated due to rain or the like from affecting the operation of the electricity supply device.

The supply of electric power from the electricity supply device 200 to the electrical vehicle 100 can be done in a contact type or in a non-contact type. Further, the power supply from the electricity supply device 200 to the electrical vehicle 100 may be a direct current or alternating current power supply.

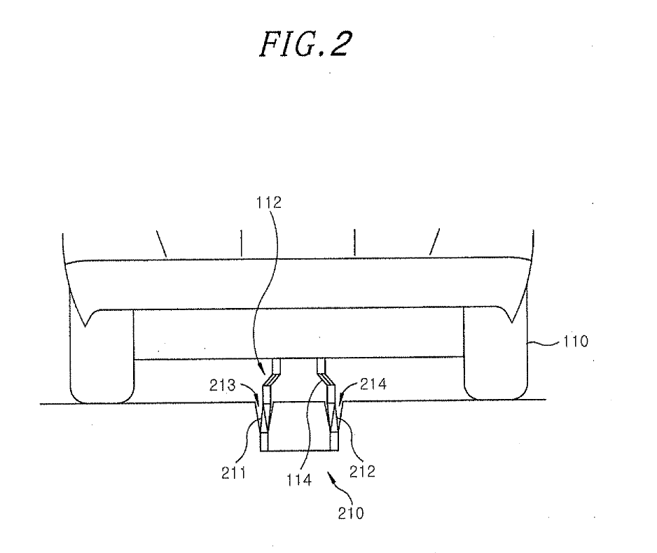

One example of contact-type DC power supply from the electricity supply device to the electrical vehicle is illustrated in FIG. 2. As illustrated therein, the electricity supply device 210 includes two power lines 211 and 212 installed underneath the road and supplies DC power to the electrical vehicle 110. The power lines 211 and 212 are each exposed to the outside through an opening. The electrical vehicle includes a connector 112 for supplying the power in contact with the electricity supply device 210 while moving or stopped on the road, and the connector 112 extends in the surface direction of the road from the bottom of the vehicle to make contact with the power lines 211 and 212.

The connector 112 can be connected to the power lines 211 and 212 in a sliding manner. In this case, one surface of each of exposed ends of the power lines 211 and 212 and one surface of an extended end of the connector 112 are electrically connected to each other. At least a portion of a transverse cross-section of each of the power lines 211 and 212 may have a polygonal shape, and at least part of the extended end of the connector 112 may have a polygonal shape. In this case, one side of the polygonal cross-section of each of the power lines 211 and 212 and one side of the polygonal cross section of the connector 112 are brought into contact with each other, and thus electrically connected to each other. Further, the polygonal shape may be a triangular shape. The connector 112 may be connected to the power lines 211 and 212 in a sliding manner or rolling manner. If the connector 112 deviates from the road provide with the electricity supply device 210 therein, it may move backward and be stored in the vehicle.

The connector 112 of the electrical vehicle 110 is preferably spring-loaded by elasticity on the electricity supply device 210 to maintain a good electrical connection state. Further, since the electrical vehicle 110 fluctuates up and down and left and right while traveling because of its suspension system, the connector 112 has a connection maintenance unit, e.g., an elastic member 114 to avoid vibration effects.

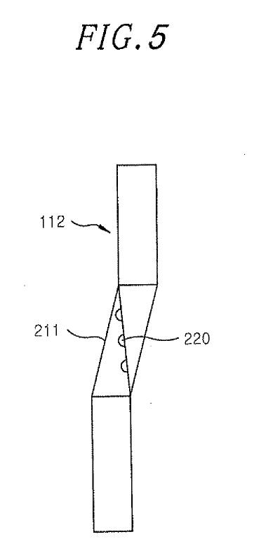

As illustrated in FIG. 5, in the electricity supply device 210, plural grooves 220 for reducing friction and abrasion are provided on the surfaces of the power lines 211 and 212 being in contact with the connector 112 of the electrical vehicle 110. Particles produced by abrasion between the connector 112 and the power lines 211 and 212 are accommodated in the grooves 220, thus preventing an increase in the abrasion or friction of the connector or electricity supply device due to these particles. These grooves may be provided at the connector 112.

If the power is supplied in a non-contact type from the electricity supply device 200 to the electrical vehicle 100, the battery 150 of the electrical vehicle 100 is charged by, e.g., an electromagnetic induction method resulting from the electricity supply device 200. To increase the efficiency of electromagnetically induced energy transfer, an alternating current power supply of about 10 to 20 kHz is required. An optimum frequency depends on the gap between tracks and the vehicle, the shape of the tracks and a receiver (pick-up installed in the vehicle), and the like.

Methods for enabling the electrical vehicle 100 to use the power supplied from the electricity supply device 200 include the following methods. The first method is that the electrical vehicle 100 drives its wheels using part of the power supplied from the electricity supply device 200 and charges the battery 150 using another part of the power. Another method is that the electrical vehicle 100 charges the battery 150 with the power supplied from the electricity supply device 200 and is supplied with all the power for driving the wheels from the battery 150.

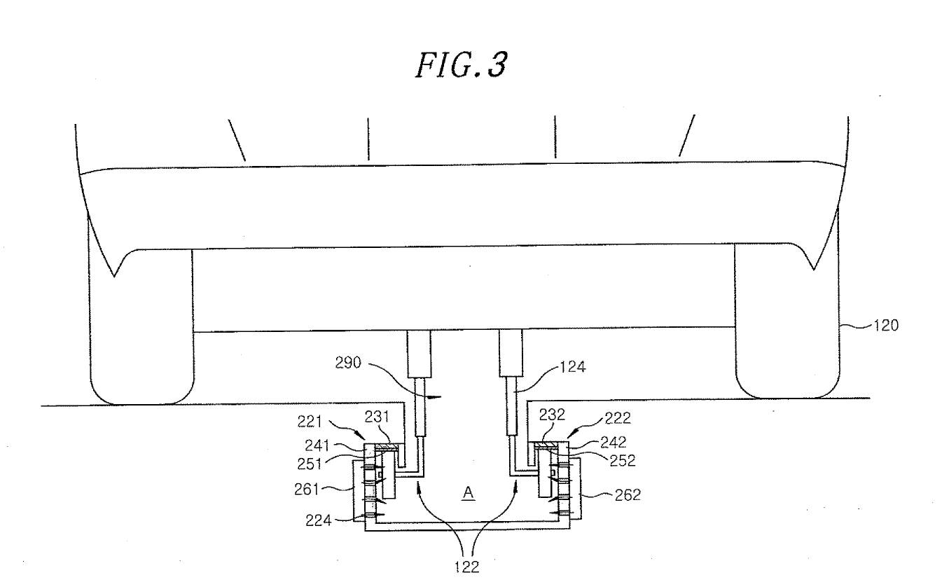

FIG. 3 illustrates another example of a contact-type electricity supply device 220. As in the embodiment shown in FIG. 2, the electricity supply device 220 has two power supply devices 221 and 222 installed underground. The power supply devices 221 and 222 extend below the road surface along the road, and has a substantially L-shape each having an upper member 231 and 232 and a side member 241 and 242. The power supply devices 221 and 222 are exposed to the outside through an opening 290. The side member 241 and 242 extends downward of the road while making a right angle with reference to the upper member 231 and 232, respectively so that the upper member 231 and 232 and the side member 241 and 242 form a right-angle corer, respectively. That is, both of the side members 241 and 242 are arranged to face each other. Electricity is provided only to the bottom surfaces of the upper members 231 and 232 of the power supply devices 221 and 222, but not to the top surface exposed to the road surface. That is, power supply lines 251 and 252 may be provided on the bottom surfaces of the upper members 231 and 232. Accordingly, the risk of electric shock is reduced even when a pedestrian comes into contact with the power supply devices 221 and 222. A duct for compressed air 261 and 262 is provided at the side members 241 and 242 of the power supply devices 221 and 222, and extends along it. Further, plural air exhaust ports 224 are provided. Air having a pressure higher than the atmosphere pressure is exhausted from the air exhaust ports 224 to a space (A) opened by the opening 290 in which the side members face each other, i.e., a lower space of the upper members 231 and 232 and blows out moisture and contaminants, thereby maintaining a good electrical connection.

The connector 112 of the electrical vehicle extends in the direction of the road from the bottom of the electrical vehicle, and is connected to the power lines 221 and 222 by, for example, rollers 224 and 225 provided at its ends. Similarly, the connector may have an elastic member 124 to maintain a good electrical connection to the power lines. For the electrical connection, the rollers 224 and 225 may be formed of conductive members.

A comparison between AC power supply from the electricity supply device to the electrical vehicle and DC power supply from the electricity supply device to the electrical vehicle is as follows. In case of using AC power, the electrical vehicle converts AC into DC to charge the battery. Accordingly, a device for converting AC to DC is provided at the electrical vehicle, which increases the weight of the car body. However, there are advantages that the electricity supply device can usually use conventional AC power supply lines (e.g., 110 V and 220 V) that are supplied to residential houses, buildings, streetlights on roads, etc., and the battery can be charged in a non-contact manner by electromagnetic induction. In case of using DC power, a large-capacity AC/DC converter is provided to supply DC to the electricity supply device. This offers higher efficiency compared to AC-to-DC conversion for each electrical vehicle, but it requires cost to install the AC/DC converter.

Meanwhile, motors for driving the electrical vehicle include both AC and DC motors. For example, a brushless DC motor, an induction motor, etc. can be used. It is preferable for an electrical vehicle of a relatively small size to employ a DC-type motor.

The electrical vehicle 100 can be guided in a mechanical or electrical manner so that it moves along a path where the electricity supply device 200 is installed.

If the electrical vehicle 100 is guided in a mechanical manner, at least one groove is provided on the surface of the road where the electricity supply device 200 is installed. The electrical vehicle 100 is guided such that at least one of the wheels of the electrical vehicle 100 moves along the groove provided on the surface of the road.

The electrical vehicle 100 may be guided to move depending on the driver's operation. In this case, it is desirable that a line that the driver can refer to is marked on the surface of the road. The driver drives the electrical vehicle 100 along this line so that the electrical vehicle 100 is properly supplied with electric power from the electricity supply device 200. The driver can guide the movement direction of the electrical vehicle 100 by a steering aid device (not shown), e.g., a handle device.

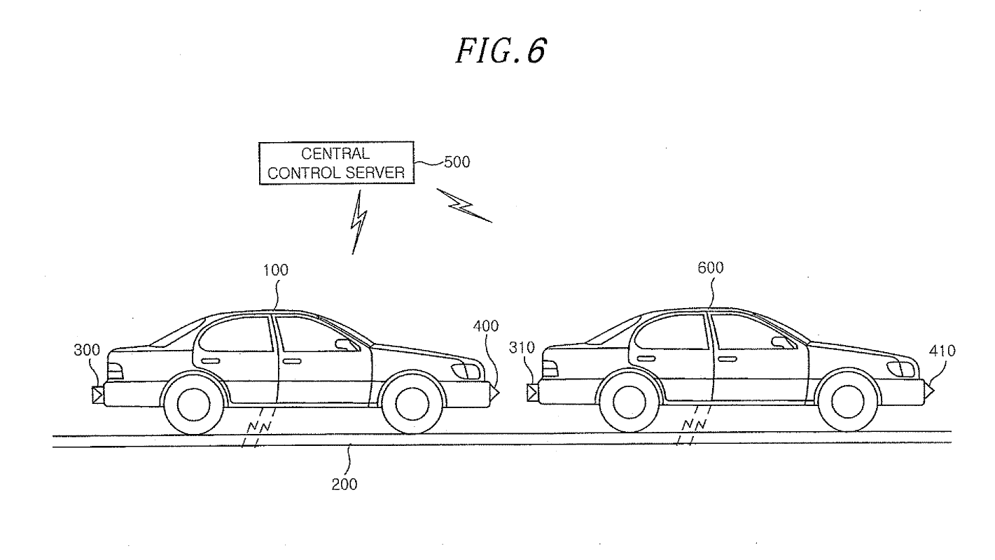

As illustrated in FIG. 6, the transport system in accordance with the present invention may include a central control server 500 for monitoring the driving status of the electrical vehicle 100. The central control server 500 may receive information such as the location, speed, etc. of the vehicle in communication with the electrical vehicle 100, or transmit information for guiding the electrical vehicle 100 to the electrical vehicle 100. Using this information, the central control server 500 can determine the traveling path of the electrical vehicle 100 and prevent traffic congestion.

The electrical vehicle 100 and the central control server 500 communicate with each other, for example, by a power line communication method. In this case, the communication between the electrical vehicle 100 and the central control server 500 is performed through the electricity supply device 200.

Electrical vehicles moving in the same direction may be coupled to each other. To this end, each of the electrical vehicles has a connection member 300 and 400 for connecting, i.e., physical or mechanical coupling to other electrical vehicles. A suction absorbing member using vacuum or a connector using magnetic force may be used as the connection member 300 and 400. Preferably, a pair of projections 400 and a groove portion 300 are provided at the front and rear surfaces of the electrical vehicle, respectively, and one of the projections 400 of the electrical vehicle 100 may be connected to a groove portion 310 of another electrical vehicle 600. Also, the projections 400 and the groove portion 300 may have raised and incised cone shapes, respectively. When plural vehicles move, with being connected to each other, it may be possible that only some of the connected vehicles are driven and the other vehicles are passively driven.

For example, a method for driving plural electrical vehicles by connecting them in a transportation system using an electrical vehicle in accordance with the present invention is accomplished by the following steps. First, the destinations and predicted movement paths of electrical vehicles moving in the front or back of a certain electrical vehicle (hereinafter, referred to as a first electrical vehicle) are checked. Next, as a result of checking the destinations and predicted movement paths of the electrical vehicles, if there is an electrical vehicle identified as moving more than a predetermined distance along the same movement path as the first electrical vehicle, that electrical vehicle and the first electrical vehicle are connected. Thereafter, whether to drive each of the connected electrical vehicles is determined in consideration of the total load of the connected electrical vehicles. Such a series of steps may be performed in each electrical vehicle or in the central control server.

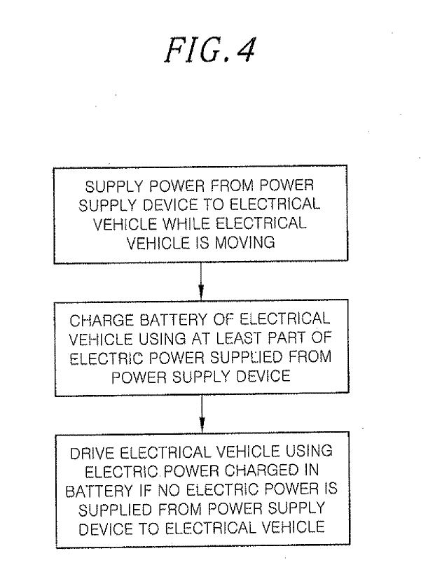

Hereinafter, a method for supplying electric power to an electrical vehicle in a transportation system using an electrical vehicle in accordance with the present invention will be described in detail with reference to FIG. 4.

While an electrical vehicle moves along a road where the electricity supply device is installed, electric power is supplied from the electricity supply device to the electrical vehicle. The battery of the electrical vehicle is charged using at least part of the electric power supplied from the electricity supply device. If no electric power is supplied from the electricity supply device to the electrical vehicle, like when the electrical vehicle veers off the road where the electricity supply device is installed, the electrical vehicle is driven on the electric power charged in the battery.

Methods for an electrical vehicle to use electric power supplied from the electricity supply device are as follows.

The first method is to drive the wheels of an electrical vehicle using part of electric power supplied from the electricity supply device and charge the battery using another part of the supplied electric power. In this case, if the electrical vehicle moves on the path where the electricity supply device is installed, the battery is charged but not discharged. The electrical vehicle is driven on the electric power of the battery only when the electrical vehicle moves to an area where the electricity supply device is not installed.

Another method is to charge the battery of an electrical vehicle using electric power supplied from the electricity supply device and drive the wheels of the electrical vehicle only using the electric power supplied from the battery. In this case, the electrical vehicle is always driven on the electric power of the battery, and the battery is charged as soon as it becomes discharged when the electrical vehicle moves along the road where the electricity supply device is installed.

While the invention has been shown and described with respect to the embodiments, it will be understood by those skilled in the art that various changes and modifications may be made without departing from the scope of the invention as defined in the following claims.

1. A transportation system using an electrical vehicle, the system comprising:
a power supply device installed below a surface of a road along the road; and
an electrical vehicle including a steering aid device for guiding the movement direction of the electrical vehicle, a battery for providing charged power if required for driving, a power acquisition device for receiving power by electrical connection to the power supply device, and a connector to be mechanically detachably connected to another electrical vehicle to travel, with being connected to the another electrical vehicle moving along the same path,
wherein, if the electrical vehicle travels on the road where the power supply device is installed, the battery is charged using at least part of the electric power supplied from the power supply device, and, if the electrical vehicle travels on a road where the power supply device is not installed, the electrical vehicle is driven using on the electric power charged in the battery, and
wherein the connector of the electrical vehicle maintains a connected state with a connector of another electrical vehicle using air pressure.

2. The system of claim 1, wherein the power acquisition device of the electrical vehicle is supplied with power from the power supply device in a contact type.

3. A transportation system using an electrical vehicle, the system comprising:
a power supply device installed below a surface of a road along the road; and
an electrical vehicle including a steering aid device for guiding the movement direction of the electrical vehicle, a battery for providing charged power if required for driving, a power acquisition device for receiving power by electrical connection to the power supply device, and a connector to be mechanically detachably connected to another electrical vehicle to travel, with being connected to the another electrical vehicle moving along the same path,
wherein, if the electrical vehicle travels on the road where the power supply device is installed, the battery is charged using at least part of the electric power supplied from the power supply device, and, if the electrical vehicle travels on a road where the power supply device is not installed, the electrical vehicle is driven using the electric power charged in the battery,
wherein the acquisition device is provided with the power from the power supply device in a contact type,
wherein the power supply device includes at least one power supply line which extends along the road underneath the road surface and is flat on at least a portion of a transverse cross-section, and
wherein the power acquisition device includes:
a connector which is flat on at least a portion of a transverse cross-section, the flat portion of the power supply line and the flat portion of the connector being electrically connected by contacting each other; and
a connection maintenance unit for pressing the connector against the power supply line by elasticity to enable the connector and the power supply line to maintain a good electrical connection state.

4. The system of claim 3, wherein the cross section of the power supply line and the cross section of the connector have a polygonal shape.

5. A transportation system using an electrical vehicle, the system comprising:
a power supply device installed below a surface of a road along the road; and
an electrical vehicle including a steering aid device for guiding the movement direction of the electrical vehicle, a battery for providing charged power if required for driving, a power acquisition device for receiving power by electrical connection to the power supply device, and a connector to be mechanically detachably connected to another electrical vehicle to travel, with being connected to the another electrical vehicle moving along the same path,
wherein, if the electrical vehicle travels on the road where the power supply device is installed, the battery is charged using at least part of the electric power supplied from the power supply device, and, if the electrical vehicle travels on a road where the power supply device is not installed, the electrical vehicle is driven using the electric power charged in the battery,
wherein the acquisition device is provided with the power from the power supply device in a contact type,
wherein the power supply device is formed in a substantially L-shape which extends along the road underneath the road surface and has an upper member and a side member, and
wherein the power supply device includes:
a power supply line for supplying electricity to the bottom surface of the upper member;
a duct for compressed air, which extends along the side member of the power supply line; and
a plurality of air exhaust ports, provided on the side member of the power supply line, for communicating the duct for compressed air with a lower space of the upper member of the power supply line, and
wherein the power acquisition device of the electrical vehicle includes:
a connector for maintaining a contact state in a manner of rolling friction with the bottom surface of the upper member of the power supply line of the power supply device during driving; and
a connection maintenance unit for pressing the connector against the bottom surface of the upper member of the power supply line by elasticity to maintain a good electrical connection state.

6. The system of claim 5, wherein the connector is a conductive roller.

7. The system of claim 1, wherein the electrical vehicle is guided to move along a path where the power supply device is installed.

8. The system of claim 7, wherein the electrical vehicle is guided such that at least one of the wheels moves along a groove provided on the surface of the road.

9. The system of claim 1, wherein the power acquisition device of the electrical vehicle is supplied with the power from the power supply device in a non-contact type.

10. The system of claim 9, wherein the power acquisition device of the electrical vehicle receives the power from the power supply device by an electromagnetic induction method.

11. The system of claim 1, wherein the electrical vehicle drives the wheels using part of the power supplied from the power supply device and charges the battery using another part of the power.

12. The system of claim 1, wherein the electrical vehicle charges the battery with the power supplied from the power supply device and is supplied with all the power for driving the wheels from the battery.

13. The system of claim 1, further comprising a central control server for monitoring the driving status of the electrical vehicle.

14. The system of claim 13, wherein the electrical vehicle and the central control server communicate with each other by a power line communication method.

15. The system of claim 14, wherein the electrical vehicle and the central control server send and receive information including the location and speed of the electrical vehicle.

16. The system of claim 15, wherein the destinations and predicted movement paths of electrical vehicles are checked to determine whether the electrical vehicles are connected.

17. The system of claim 16, wherein whether to drive each of the connected electrical vehicles is determined in consideration of the total load of the connected electrical vehicles.

18. (canceled)

19. The system of claim 1, wherein the car body of the electrical vehicle is made of a composite material and is thus lightweight compared to a car body entirely made of metal.

20. The system of claim 19, wherein the composite material is selected from a group consisting of glass fiber, carbon fiber, and aramid fiber.

21. A method for driving plural electrical vehicles by connecting the electrical vehicles in a transportation system using an electrical vehicle of claim 1, the method comprising:
checking the destinations and predicted movement paths of electrical vehicles moving in the front or back of a first electrical vehicle;
as a result of checking the destinations and predicted movement paths of the electrical vehicles, if there is an electrical vehicle identified as moving more than a predetermined distance along the same movement path as the first electrical vehicle, connecting the identified electrical vehicle and the first electrical vehicle by connection members of the electrical vehicles; and
determining whether to drive each of the connected electrical vehicles in consideration of the total load of the connected electrical vehicles.

22. A transportation system using an electrical vehicle, the system comprising:
a power supply device installed below the surface of a road along the road; and
an electrical vehicle including a battery for providing charged electric power if required for driving, and a power acquisition device for receiving electric power by electrical connection to the power supply device and charging the battery,
wherein the power supply device includes at least one power supply line which extends along the road underneath the road surface and is flat on at least a portion of a transverse cross-section, and
wherein the power acquisition device includes:
a connector which is flat on at least a portion of a transverse cross-section, the flat portion of the power supply line and the flat portion of the connector being electrically connected by contacting each other; and
a connection maintenance unit for pressing the connector against the power supply line by elasticity so as to enable the connector and the power supply line to maintain a good electrical connection state.

23. The system of claim 22, wherein the cross section of the power supply line and the cross section of the connector have a polygonal shape.

24. The system of claim 23, wherein the polygonal shape is a triangular shape.

25. The system of claim 24, wherein a plurality of grooves for reducing friction and abrasion are provided on the surfaces of the power lines being in contact with the connector.

26. A transportation system using an electrical vehicle, the system comprising:
a power supply device installed below the surface of a road along the road; and
an electrical vehicle including a battery for providing charged electric power if required for driving, and a power acquisition device for receiving electric power by electrical connection to the power supply device and charging the battery,
wherein the power supply device is formed in a substantially L-shape which extends along the road underneath the road surface and has an upper member and a side member, and the power supply device includes:
a power supply line for supplying electricity to the bottom surface of the upper member;
a duct for compressed air extending along the side member of the power supply line; and
a plurality of air exhaust ports, provided on the side member of the power supply line, for communicating the duct for compressed air with a lower space of the upper member of the power supply line, and
wherein the power acquisition device of the electrical vehicle includes:
a connector for maintaining a contact state in a manner of rolling friction with the bottom surface of the upper member of the power supply line of the power supply device during driving; and
a connection maintenance unit for pressing the connector against the bottom surface of the upper member of the power supply line by elasticity so as to maintain a good electrical connection state.

27. The system of claim 26, wherein the connector is a conductive roller.
